(19) United States
(12) Patent Application Publication
(10) Pub. No.: US 2015/0186602 A1
(43) Pub. Date: Jul. 2, 2015

(54) System and Method for Priority-Based Management of Patient Health for a Patient Population

(71) Applicant: VGBio, Inc., Naperville, IL (US)

(72) Inventors: Robert Matthew Pipke, Oak Park, IL (US); Stephan W. Wegerich, Geneva, IL (US)

(73) Assignee: VGBio, Inc., Naperville, IL (US)

(21) Appl. No.: 14/400,741

(22) PCT Filed: May 17, 2013
(86) PCT No.: PCT/US2013/041639

§ 371 Date: Nov. 12, 2014

Related U.S. Application Data
(60) Provisional application No. 61/648,945, filed on May 18, 2012.

(51) Int. Cl. G06F 19/00; G06Q 50/24

(52) U.S. Cl. CPC G06F 19/322; G06Q 50/24; G06F 19/3431

(57) ABSTRACT

Efficient management of patient health of a population of patients, such as chronically ill patients living at home and monitored with remote continuous wearable or implantable physiology telemetry, is provided by means of a computer application for rendering a prioritized list of patients sortable according to a number of distinct criteria.

This invention was made with Government support under Contract VA118-11-P-0031 awarded by the Department of Veterans Affairs. The Government has certain rights in the invention.

### BACKGROUND OF THE INVENTION

1. Field of the Invention

The present invention relates generally to the field of patient health monitoring, and more particularly to proactive management of patient health for a population of patients monitored with continuous multivariate biosignal telemetry.

2. Brief Description of the Related Art

Given the increasing portion of the population living longer and therefore living with chronic disease, and the tremendous cost to the health care system of caring for such patients, attention has begun to shift to proactive management of such populations of patients to keep them from requiring emergency care and hospitalization. Such populations of patients may be found in nursing homes and also living at home. In order to proactively manage the health of such patients, some institutions are using an approach of comprehensive, scheduled follow-up whereby clinical staff contact patients on a routine basis to ensure compliance with medications, diet and exercise that keeps the chronic disease in check. However such an approach is expensive in terms of the sheer amount of contact time required by clinical staff. Moreover, because such follow-up is done on a predetermined schedule, actual health deterioration events can easily be missed.

It is highly desirable to have quantitative insight into the health of the patient, and for this purpose many new monitoring technologies have been developed to measure one or more physiological parameters on a continuous or periodic basis. These technologies include measurement devices used or worn by the patient on a removable basis, or implanted devices with sensors that may be read continuously or only in proximity to a through-skin reader. Such data is transmitted and aggregated centrally, with the hope that signs of actual health deterioration (as is prone to occur in these patients) can be detected early, guiding contact and intervention by clinicians with those who need it most. Low impact, low cost medical interventions can be utilized to correct the health problem and prevent hospitalization.

The problem with this is that the amount of data being generated is tremendous. Simple, conventional techniques for automatically detecting abnormal data, such as thresholds, is confounded by the larger degree of normal variation present in physiological parameters when a patient is living an active life at home in contrast to being supine and sedated in a hospital bed. More sophisticated analyses are required to detect subtle early warning signs of impending health deterioration. Such techniques utilize multiple physiological parameters, and recognize patterns of physiology. Multivariate physiology data holds promise for early detection of subtle signs of deterioration while still actionable, against the backdrop of ambulatory living with its high degree of normal variation in signals. However, data fusion of multivariate data into a decision score is difficult, and in any case health deviation severity is just one component of information necessary for efficient and effective management of patient health. Managing a large number of patients—any of whom could exhibit early signs of deterioration in their chronic condition requiring medical intervention to avoid hospitalization, but in which only a small fraction will be abnormal at any time—can pose a severe burden on clinical staff bandwidth looking for the proverbial needle in the haystack. In order to take advantage of the sensitivity of multivariate analysis, there is a need to fuse the data in a way that allows for comparison across patients to know who needs attention with higher priority. Traditional electronic medical record (EMR) systems allow for display of patient-specific information, but are invariably oriented toward a single patient record at a time, rather than a list of patients ranked in some way. What are needed are new clinician-oriented applications that efficiently facilitate the new kind of workflow characteristic of proactive management of a population of patients, especially in the context of the heterogeneous indications across patients that arise from multivariate analysis.

Critically, one problem with data fusion into scalar indexes of wellness by which patients might be compared, is that the score is usually attributed to the current moment. While past score trending of time series of such health indexes can provide a level of confidence in the immediate score for a clinician charged with reacting to such an index, this is meaningful only in the context that the score requires emergency action. This is not the case in long-term health monitoring in the ambulatory, at-home or nursing home environment, because of the combination of motion artifact, the need for earliest detection, and the ebb and flow of wellness in that context. Alerts at the current instant are not necessarily emergencies, but are indicators/predictors of what may come over days. Therefore, reacting to the instant alert value can be counterproductive in terms of efficiency. What is needed is a clinician-oriented application for management of patient populations on a proactive basis that provides some kind of accumulative index that integrates the health index time series so that patients can be ranked for priority handling with the limited time clinical staff has available. Further, what is needed in such an application is facilitation of workflow characteristic of the inquiry-intervention-followup paradigm of proactive care. Moreover, an application of this kind needs to facilitate hand-off between shifts, so that patient issues are not missed and also patients are not redundantly handled. An additional quandary is that some remote physiology monitoring systems are used at the discretion of the patient, and may not provide regular, continuous data streams—hence “staleness” of health index data may be an additional factor in ranking the priority of patients to reach out to. Hence systems in the prior art that render instant alert values and rank patients according to those values are not sufficient or optimized in the context of managing patient populations at home, especially where data may be sporadic or dependent on the participation and compliance of the patient.

### SUMMARY OF THE INVENTION

The present invention provides a novel computer-based system and method for efficient proactive management of patient health for a population of patients, such as a population of chronically ill patients living at home or a population of patients in a nursing home, who are being monitored with continuous or periodic vital sign or biosignal telemetry. In this context, each such patient may be instrumented with bed-side monitoring equipment, with wearable sensors or with an implanted device (such as a pacemaker) that has sensors, and data for all such patients is aggregated and analyzed centrally. Analysis of the data comprises data fusion of multiple physiological parameters into a univariate time series index of health normality that is sensitive to subtle deviations in the physiology of a patient from normal behavior. Such deviations reflected in the health index provide early indication that a patient's brittle health may be deteriorating, and timely medical intervention is needed to avoid an emergency hospitalization.

The computer-based system of the invention facilitates prioritized proactive medical intervention by clinicians with patients by means of sorting and prioritization methods and display visualizations that aid clinicians in determining which patients to engage with first, and which patients may need no immediate unscheduled engagement. Advantageously, the system of the present invention facilitates sorting of patients based on a scalar ranking (“health progression ranking”) derived from the time series index of health normality. This scalar ranking incorporates and fuses information about the severity of health deviation, the persistence of such deviations, the richness or paucity of the information, and the freshness of the information in time, in a novel and unique fashion that optimizes prioritization. The system further facilitates rapid chronological visualization, sorting and tracking of contact with, instructions to, interventions with and follow-up with patients (generally “patient encounters”), thereby enabling efficient hand-off between clinicians. The system further facilitates sorting on patient compliance with use or wearing of any voluntary vital sign monitoring device(s) the data from which is used by the system to determine health status, thereby prioritizing contact with patients who need to be encouraged regarding compliance. The system further advantageously facilitates efficient logging of patient encounters as progress notes and scheduling of follow-ups to optimize management of a large population of patients with minimal clinical staff.

The system preferably comprises computer code transmissible over a network such as the internet or a corporate intranet for rendering in a client application such as a web browser a set of display screens or browser pages for displaying to the clinician visualizations of patient prioritization according to the invention. The system displays a table of patients, sortable according to the scalar ranking derived from the time series index of health normality. A graphical user interface (GUI) widget is associated with the scalar value for each patient and serves as a chronological visualization of both the severity and progression of the time series health index as well as contextual information such as time of day, date, when data was or was not acquired from the patient (compliance with data collection) and other relevant factors. The table can also be sorted according to chronology of patient encounters inclusive of past contact and interventions as well as future scheduled follow-ups. The table can also be sorted according to a ranking of patient compliance with the use of a data acquisition device such as a wearable sensor system. The system preferably further has a GUI widget for display of information specific to a selected patient in the table, which widget can appear on the display when the clinical user selects a row of the table. This patient info widget can display medical history, patient encounter narrative history, medication regimen, contact information, demographics and photo.

The client application used by the clinician can reside on a desktop computer, on a virtualized computer session executed on a server and rendered on the remote display of a computer used by the clinician, on a portable tablet computer, or on a mobile phone of the clinician. The source of data for monitoring patient health can be bedside monitoring equipment for a patient confined to a bed in a hospital or nursing home, one or more wearable devices capable of capturing in onboard memory or wirelessly transmitting physiological data acquired from the wearable instrumentation, or one or more implanted devices which may have as a primary or ancillary function the capture of the physiological data from sensors in or connected with the implantable device(s). In one embodiment, the system comprises a database server for receiving and storing physiology data from the patient and storing analytical results; an analytics server for performing analysis of patient physiology data and storing in the database server said results; and a web server for serving pages as transmissible program code and data renderable by a client web browser to display the GUI widgets of the present invention and to facilitate data entry related to patient encounters by the clinician.

The present invention is well suited for use with monitoring methods in which multiple physiological parameters are measured and analyzed using a model of normal multivariate variation. More particularly, a series of observations of multiple biological parameters is input to an empirical model of normal behavior for those parameters, which outputs an estimate of what the parameters should be. The empirical model can be personalized to the patient, thereby accommodating the patient's unique physiological behavior even in the presence of a chronic disease. The estimates are compared to the actual measured values to provide differences, or residuals, for each parameter. Instead of applying thresholds, rules or statistics to raw measured values as is done conventionally, health problems are revealed by analyzing the residuals provided by the model. By performing analysis on the residual data instead of the raw data, such an approach importantly accommodates normal biological variation in the measured parameters created by changing metabolic demands of living at home or in a nursing home.

A variety of biological parameters are amenable to monitoring and analysis according to the invention. Typical physiological parameters such as heart rate, respiration rate, respiratory tidal volume, blood oxygenation, blood pressure, and similar parameters that characterize the cardiopulmonary control system of the human body are informative for purposes of the invention. Novel parameters that are being developed or that will be developed in the future—such as optical in situ determination of blood constituents, bioimpedance across portions of the body indicative of fluid retention, localized blood vessel pressures and flow rates—are also usable in the present invention.

### BRIEF DESCRIPTION OF THE DRAWINGS

The novel features believed characteristic of the invention are set forth in the appended claims. The invention itself, however, as well as the preferred mode of use, further objectives and advantages thereof, is best understood by reference to the following detailed description of the embodiments in conjunction with the accompanying drawings, wherein:

FIG. 1 shows an overview of a remote health monitoring architecture according to the invention;

FIG. 2 shows a graphical user interface (GUI) display of a tabular list according to the invention for prioritizing patient management;

FIG. 3 shows a column of the GUI tabular list display with a visualization widget according to the invention for prioritizing patient management based on health index progression represented on a time axis;

FIG. 4 shows a display of a progress note form according to the invention; and

FIG. 5 shows a column of the GUI tabular list display with a visualization widget according to the invention for representing patient encounters and pending follow-ups along a time axis.

### DETAILED DESCRIPTION OF THE PREFERRED EMBODIMENTS

The present invention facilitates efficient management of patient health of a population of patients being monitored with physiological sensors, by analyzing and presenting patient health data to a clinician in an interactively sortable, prioritized manner based on cumulative time series behavior of a health index. The health index is a scalar value generally obtained, as described below in greater detail, from the fusion of analytical results based on multiple physiological variables from the patient, and is indicative of the normalcy or abnormality of the patient's physiology at a point in time. Continuous analysis of physiology data results in a time series of health index values. The inventive approach is exceptionally advantageous in the context of management of chronically ill patients in their at-home or nursing home environment, where early detection of persistent indications of deteriorating health suggests the need for timely (but not necessarily emergency) medical intervention to avoid later emergency conditions. Home living or nursing home living involves considerably more variation of the normal metabolic demands on the body than is seen in a bed-bound patient in a hospital, and poses a challenge to conventional univariate medical monitoring. Abnormal behavior of a patient's physiology, compensatory to an incipient health issue (such as pneumonia in a patient with chronic obstructive pulmonary disease (COPD) or exacerbation in a heart failure patient) may be only intermittently detectable at the earliest stages, especially against the background of normal variation in the at-home environment. The problem of deciding if and when to intervene medically with the patient based on the instant value of a health index can be intractable in this context. Reacting whenever the instant value of the health index breaches a threshold can result in a high false alert rate and is counterproductive to efficient management of the patient population, especially by limited clinical staff in a remote patient management context. Merely setting the threshold higher may cancel out the benefit of early intervention. The present invention mitigates this issue by assessing and ranking patients based on the cumulative time series behavior of the health index, and prioritizing the attention of the clinician. Effectively, whatever time the clinician has to manage patients is spent on the highest priority patients regardless of how far down the ranked list the clinician can get.

In addition, monitored data from the patient may be only intermittently available rather than available continuously, due to compliance with using monitoring equipment or devices, device dysfunction, network connectivity or other factors. The freshness or staleness of analytical results and of the health index is incorporated into the priority ranking of the present invention, and is further visualized in GUI widgets for ease of use by the clinician. Further, the invention also facilitates a distinct ranking based only on compliance, helping the clinician identify patients who need encouragement to adhere to the monitoring regimen, or helping to identify dysfunctional monitoring devices.

Clinician workflow is facilitated by the present invention by an additional GUI widget for visualizing patient encounters and planned follow-ups, and alternative rankings based on last contact and based on next scheduled follow-up. Patient encounters (whether due to proactive inquiry driven by detection of health deterioration, to patient-initiated contact, or to scheduled follow-up) are easily tracked in the system as narrative progress notes with optionally associated follow-ups.

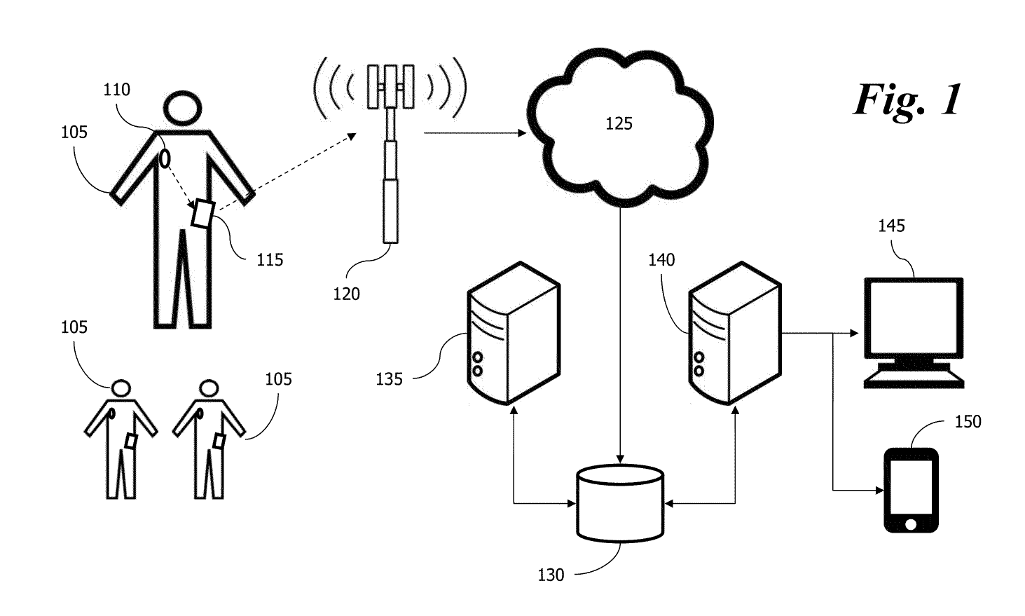

The context of the invention is well understood on examination of FIG. 1, which depicts one embodiment of a monitoring architecture for centralized health management of a patient population. Patients 105 each have one or more devices 110 for sensing physiological signals. Devices 110 can be wearable non-invasive devices adhered to the skin, or may be implanted devices. Such devices may measure for example one or more of electrocardiogram, bioimpedance, temperature, accelerometer vibration, photoplethysmograph, pressure, flow, and the like. From these biosignals, physiological parameters such as heart rate (HR), respiration rate (RR), blood pressure (BP), pulse transit time (PTT), blood oxygenation (SpO2), posture, gross activity and so on, may be derived as feature variables (vital signs). Devices 110 can wirelessly transmit data to a data hub 115 which may be a smartphone carried by the patient or a near-range wireless receiver located near the patient. As an alternative to a smartphone, hub 115 may be a transceiver positioned in a mattress to energize an implanted device 110 and receive data there from when the patient sleeps on the mattress. The data hub 115 is disposed to upload physiological data from the patient via telecommunications network 120, which may be a digital cellular network. Data is muted from the telecommunications network preferably via internet 125 to remote centralized data store 130. Data store 130 collects patient data for all patients 105 in the monitored population. Analytics server 135 analyzes the multivariate physiological data to determine the health index values for the patient 105, as described in greater detail herein below. Web server 140 serves web pages with GUI widgets according to the invention populated with the patient physiological data and health index values stored in data store 130, to display ranked health status information for all patients on clinician workstation 145 or clinician smartphone or tablet 150.

In a typical use scenario, patients 105 may be monitored for several hours a day while they wear noninvasive devices 110. They may wear such devices at their convenience, sometimes removing the devices. If the patient is in a nursing home, staff may remove the devices in order to bathe the patient. Such devices may be daily removable and rechargeable, and may even be disposable. If the device is an implanted device, it may generate continuous data, or may take sensor readings only periodically, to conserve battery life. In all events, copious physiological data tracking the vital signs of the patient through a range of metabolic demand will be available for analysis. By way of example, a wearable device may be worn by a patient during awake hours of the day, and may generate continuous biosignals that are used to derive (either in the device processor or in the smartphone processor) vital signs at a one-minute data rate, such that 480 readings of multiple feature variables are obtained over 8 hours. These vital signs will exhibit a considerable range of heart rate, respiration rate, respiratory effort, blood pressure, posture, activity, blood oxygenation and so on, as the patient navigates his or her daily routines.

In the current health care system, no clinician has the time to continuously or even periodically observe physiological variables of patients in these kinds of quantities. According to the invention, software-automated analysis of the data is used to automatically determine and recognize deviations from normal physiology patterns, and bring them to the attention of clinicians. In a preferred embodiment, described in further detail below, an empirical model of the patient's physiology is used as a dynamic baseline to compare with physiological feature variables monitored from the patient. In response to receiving an observation of a contemporaneous set of physiology values measured on the patient (e.g., a heart rate, a respiration rate, a pulse transit time, a blood oxygenation, etc., determined as an average over a particular minute), the model estimates a set of corresponding values that would be expected of normal physiology. The difference between the estimated values and the monitored values yields residuals that can be combined statistically to make an instant determination of an index value of health normalcy for the combination of observed variables. By way of example, comparing the model estimates to the measured values to generate residuals may indicate the patient has a slightly elevated minute heart rate and a slightly decreased minute SpO2; fusing these residuals using a statistical likelihood of seeing this combination and magnitude of residuals may then set the instant health index for that instant set of minute measurements to a scalar value indicating “moderate anomaly”. That health index value is then stored in the data store for that patient corresponding to that minute in time. For each observation of feature variables, a health index value is repeatedly determined; over 60 minutes of minute-rate vital signs, 60 health index values may be generated. If an alternative data rate is chosen, such as a quarter-minute rate, then health index values may be determined up to 240 times an hour.

Further according to a typical use scenario, a team of clinicians responsible for proactive management of a patient population may comprise one or more nurses, nurse practitioners or physicians, who daily or periodically view the web site served by web server 140. Based on the indications presented therein by the present invention, the clinical team member may identify one or more patients to investigate in a proactive manner. The clinician will typically call such a patient to inquire about the patient's wellness, recent behavior, compliance with diet, compliance with medications, and so on, in an attempt to resolve any incipient health issue flagged by the system. Low-impact medical interventions that can in this manner change the course of the patient's health trajectory include (temporary) modification of medication regimen; encouragement of compliance with medications, diet and behavior; and scheduling a preemptive clinical or hospital visit. The clinical team member then enters a narrative progress note and may optionally schedule a follow-up reminder for a day or two later to assure follow-through by the patient with instructions.

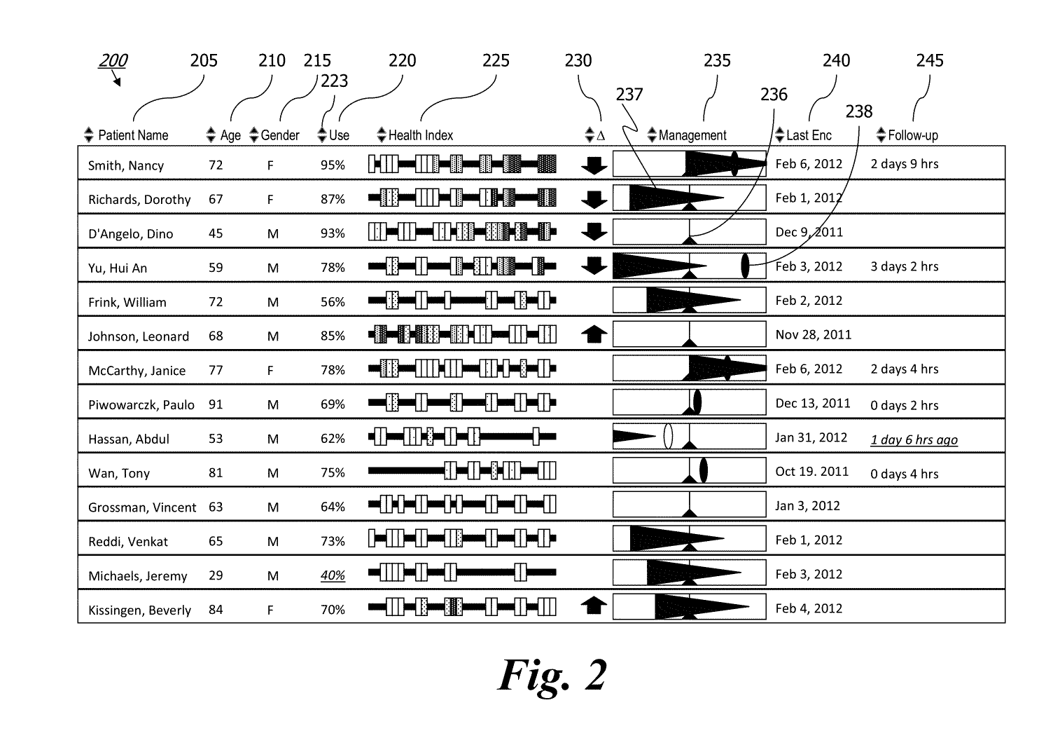

Turning to FIG. 2, the present invention facilitates the above workflow by means of the display of GUI widgets in a table format as shown therein. Table 200 displays all patients in the population, one patient per row. The content of the table can be filtered by search criteria (not shown), to display a subpopulation of the patients. For each patient, the name 205, age 210 and gender 215 is displayed for easy identification of the patients. Other fields of identifying data may also form such columns, such as medical record number, weight, and so on.

The remaining columns are particularly salient to the objectives of the invention. Column 220 contains a scalar value corresponding to an assessment of patient compliance with the use of any voluntary monitoring device(s). This value can be computed based on criteria established by the medical institution managing the patient population, e.g., 100% compliance corresponds to no less than 4 hours per day for 4 days per week of device use to provide data for monitoring. Compliance less than 100% can be determined by a number of approaches as detailed herein below. By clicking on the sorting icon 223 (similar sorting icons top each column), the clinician can sort the patients in the table to see who has lowest compliance, and contact particular patients to encourage compliance in a prioritized manner that makes the best use of the clinician's time.

Column 225 contains a visualization widget for each row showing a time series progression of health index values as colored, shaded or hatched blocks of time. The horizontal axis of the widget is a time axis that represents a system-configurable duration, with the current time that the clinician loaded the web page corresponding to the rightmost edge of the widget. The leftmost edge of the widget corresponds to a prior time offset that can be globally configured according to the preferences of the medical institution, e.g., one week ago, that is the widget represents the most recent week of time. Time along the axis may be divided into discrete blocks. By way of example, a block may correspond to an hour, and if the time span of the widget is configured to be one week, then the widget would have 168 blocks. (FIG. 2 is illustrative only and not shown with the full complement of 168 blocks for all hours that occur in a week, in order to clearly show hatching of the blocks). At blocks of time when data has been acquired from the patient and health index values successfully computed, the blocks are rendered with a color, shade or hatch corresponding to the severity of the health index values at that time. Where no data was acquired or no health index could be computed, the block is absent or there is a no color/shade/hatch. This visualization can be easily understood by the clinician to convey the progression and persistence of health index severity as well as the staleness or freshness of data and the compliance of the patient with providing data (wearing a voluntary use device). Moreover, a scalar value derived from the data visualized in this widget is associated with each patient within the table so that the table can be sorted on this column 225; the scalar “health progression” value is calculated from the time series of health index values, as described in further detail below. Sorting/ranking by this column enables the clinician to efficiently prioritize patients who exhibit a more anomalous physiological behavior compared to that patient's normal health, while at the same time enjoying the benefit of an intuitive visualization of the progression. Notably, this is not a ranking of absolute health of patients, as some patients are generally more compromised than others at baseline; instead this ranking relates to the change in the patient's health relative to the patient's baseline (“normal”) physiological behavior.

Column 2304 provides a visual indication of health trajectory: Patients who have health that appears to be increasingly deviating with time are indicated with a “down” arrow, while patients who are recovering from an interval of anomalous health are indicated with an “up” arrow. In one embodiment, the color and/or size of the arrow can be adjusted to reflect the scale of the trend, as detailed further herein below. This column is also sortable based on a scalar value associated with the icon color/size and direction.

Visualization of management of the patient is facilitated in the widget of column 235. As in column 225, the widget of column 235 represents a horizontal timeline. However this timeline extends into the future as well as into the past, such that the position of “now” is indicated by a vertical line and triangle 236 in the middle of the timeline. The purpose of this column is to visually show past patient encounters and scheduled follow-ups, both upcoming and overdue. In short, patient encounters are represented by tapering horizontal triangles 237 in the figure (fading coloration or shading is preferred in the color web page display of the invention), representing the fading relevance over time of that encounter with the patient. Follow-ups scheduled by the clinician as a reminder to check on patient outcome and compliance with medical instructions are shown in the figure as ovals 238, which are differently colored/shaded if they become overdue. Advantageously, the clinician can easily tell at a glance whether the patient of any row has been recently managed or not; in tandem with column 225, the clinician can easily differentiate at a glance those patients with severe health anomalies who need attention (proactive inquiry to investigate the anomaly), from those with severe health anomalies who have already been recently dealt with. This is especially critical to support hand-off between clinicians and between shifts. The details of this visualization column are further described below.

Column 240 identifies the date of last patient encounter. It enables the clinician to sort the table according to most recent encounter date. Column 245 similarly lists the earliest pending/open follow-up of each patient, which can be either the nearest future follow-up or most overdue incomplete follow-up, whichever is earlier. This allows the clinician to sort the table according to immediacy of follow-ups that need to be made. Once a follow-up is made by contacting the patient, the follow-up is converted to a progress note and is resolved from this list.

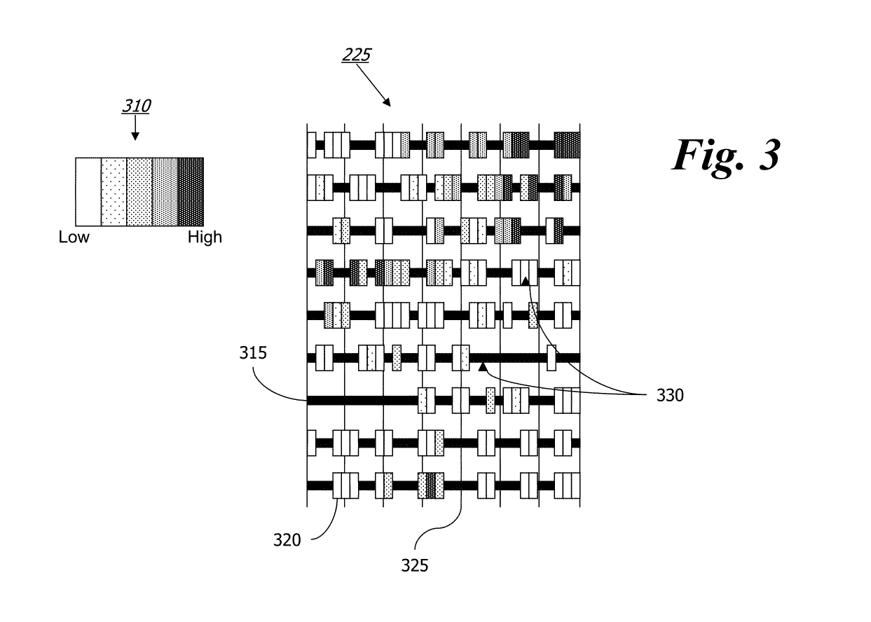

Turning to FIG. 3, the column 225 is now described in greater detail. This column displays a widget for each patient comprising a timeline 315 that represents a pre-configured duration extending from the current time that the clinician loads the web page, at the right edge, to an offset to the past, at the left edge. Preferably, this is measured in days; most preferably 7-14 days. This timeline displays both a visualization of the measure of the health index over time, when the patient has monitored data, as well as the time gaps in which no monitoring occurred. According to one embodiment of the invention, the health index data that is computed from the monitored feature variables of the patient is visually summarized into blocks 320 of time within the timeline 315. The block 320 can be chosen in size to represent no less than one pixel width on the display. For example, if the duration of the timeline 315 is 7 days, then time block 320 can represent one hour, and the widget should have a minimum width of 168 pixels, so that each hour can be represented by no less than one pixel. The widget can be proportionally scaled in size above this minimum width as screen and window size permit, as is known in the art for rendering DIV elements or SVG elements in markup code understood by most browser clients. An ensemble of gradations 310 maps the summarized value of the health index for the time block 320 into a color, shade or other hatching which visually conveys to the clinician the degree of health normalcy or abnormality exhibited for that time block. In a preferred embodiment, the map 310 ranges from green to yellow to red in three or more color steps, for health index summary values ranging from normal to abnormal; gaps in monitoring are colored gray, and may also have shorter vertical dimension.

In one embodiment, health index values may be summarized for the display purposes described above by averaging the values in a time block. For example, if monitored data occurs at a one minute data rate, and therefore health index values are also computed at a one minute data rate, health index values may be averaged over each hour to derive an hourly average health index value, which is used for the color/shade mapping 310. Due to the possibility of intermittent monitoring and/or intermittent calculation of a minute health index value, a minimum count of minute health index values can be required within an hour time block in order to render an hourly mapped value; otherwise the hour is shown as a gap in monitoring. Alternative methods of generating the summary value can be used, including: simple mean; simple median; trim-mean (remove selected percent of values from top and bottom of ordered list of health index values, and compute mean of remaining values); trim-median (remove selected percent of values from top and bottom of ordered list of health index values, and compute median of remaining values); and olympic filter (remove highest and lowest value, compute mean of remaining values). According to a preferred embodiment of the invention using minute-rate data, the time block is one hour, the minimum required count of legitimate health index values is 15, and the summary value for the hour is the trim-mean of health index values in the hour with 10% removal from top and bottom.

In an alternative embodiment of this visualization widget for health progression, fixed time blocks 320 are not used, but instead health index values are used at the native data rate (e.g., minute) for rendering coloration/shading on a width-wise pixel-by-pixel basis. This achieves fundamentally the same objective of the invention, namely that of providing the clinician an intuitive visualization of patient health progress over a defined relevant timeframe. In this approach, the size of the widget on the display, which may be a function of the zoom/size the clinician has applied to the browser or client application window, defines the time range that a width of one pixel represents. The start and end time within the duration of timeline 315 of the pixel-width is used to select health index values of the patient that fall within that pixel-width. As before, a minimum number of legitimate health index values can be required to colorize the pixel-wide sliver, for example, not less than 10% of the total possible health index values that could occur in that time range; otherwise the pixel-wide sliver is treated as a gap in monitoring. There are then two alternatives for determining the color of the pixel-wide sliver. According to a first approach, the color/shade value from map 310 of each health index value in the time range of the pixel-width is blended to provide an average pixel coloration/shading. Blending can be achieved by averaging the shade, or averaging color values along a color map. In a second approach, a sequence of rules is applied that prioritize certain colors/shades in a winner-takes-all manner. By way of example, the rule sequence can first assign the pixel-width sliver the color/shade of the most severe gradation of map 310, if 20% or more of the health index values therein have that gradation; if that isn't met, the rule sequence then might assign the sliver the color/shade of the next most severe gradation if 35% or more of the health index values therein have that gradation; and so on. In this way, the presence of a significant, though minority, count of severe health deviations remains highlighted in the visualization, effectively giving severe health deviations more weight. In a preferred embodiment, using minute data and where the most severe health index value is mapped to the color red, a pixel-wide sliver of the health progression visualization widget is assigned the color of red if 25% or more of the health index values in the time frame of the sliver map to red; otherwise the sliver color is blended based on the health index values that occur within the time frame thereof.

The widget of column 225 can also advantageously be marked with date and time gridlines 325. These gridlines help the clinician intuitively understand the date and time of day to which the data corresponds. Gridlines may alternatively be rendered as background shading along the timeline 315 corresponding to sunrise and sunset in the time zone of the patient. Patient encounters can also be mapped to the widget as markers 330, located proportionally along timeline 315 commensurate with the timestamp of the patient encounter. Patient encounter timestamps are the date and time of contact with the patient.

An important inventive aspect is that the information of column 225 can be used to sort table 200. This is achieved in the present invention by associating a scalar value with each patient derived from the health progression data visualized in column 225. This scalar value optionally can be displayed outright in a column of its own (not shown), but preferably it is simply hidden and used for sorting when the sorting icon at the top of column 225 is clicked. The scalar value is determined as a function of the time series of health index values. The functional form should generally give greater evidentiary weight to more recent health index values. In a preferred embodiment, an exponential weighted average across all health index values found in the time range corresponding to the timeline 315 is used to compute the scalar health progression value. This exponential weighted average can be computed according to the following steps:
1. Determine the count N of all valid health index values found in the time range of the timeline 315. For example, if a patient wears a voluntary monitoring device for exactly half the time, and the timeline covers 1 week, and the data rate is once per minute, it can be expected that 7 days×24 hours/day×½×60 samples/hr=5,040 samples of the health index may be found, that is, N=5,040.
2. Define a bandwidth A. As a default, A=N/2.
3. Compute the health progression scalar as the exponential weighted average E using all health index values (h₁, h₂, . . . , h_{N}) as:

$$E = \frac{{\sum }_{i = 1}^{N} h ( i ) \cdot {e}^{\frac{- ( N - i )}{A}}}{{\sum }_{i = 1}^{N} {e}^{\frac{- ( N - i )}{A}}} \qquad ( Equ . 1 )$$

It can be seen from Equation 1 that each value hᵢ is weighted according to an exponential factor that grows as i approaches N, in other words as the value is more recent in time.

While the above calculation of the health progression scalar is illustrated using the native data rate of the health index values, it can also be alternatively computed using the time block averaged values that were used to colorize/shade time blocks 320. In that case, N will be a smaller number (the number of time blocks 320 for which there is a summary value), but Equation 1 is still applicable.

In another embodiment of the invention, the value N can be determined for a time window that is different from, but overlapping with, that of the timeline 315. For example, the timeline 315 can be configured to show one week of time, whereas the calculation of the health progression scalar can be made with reference to health index values going back for a globally configured longer time, e.g. 14 days, or shorter time, e.g. 5 days.

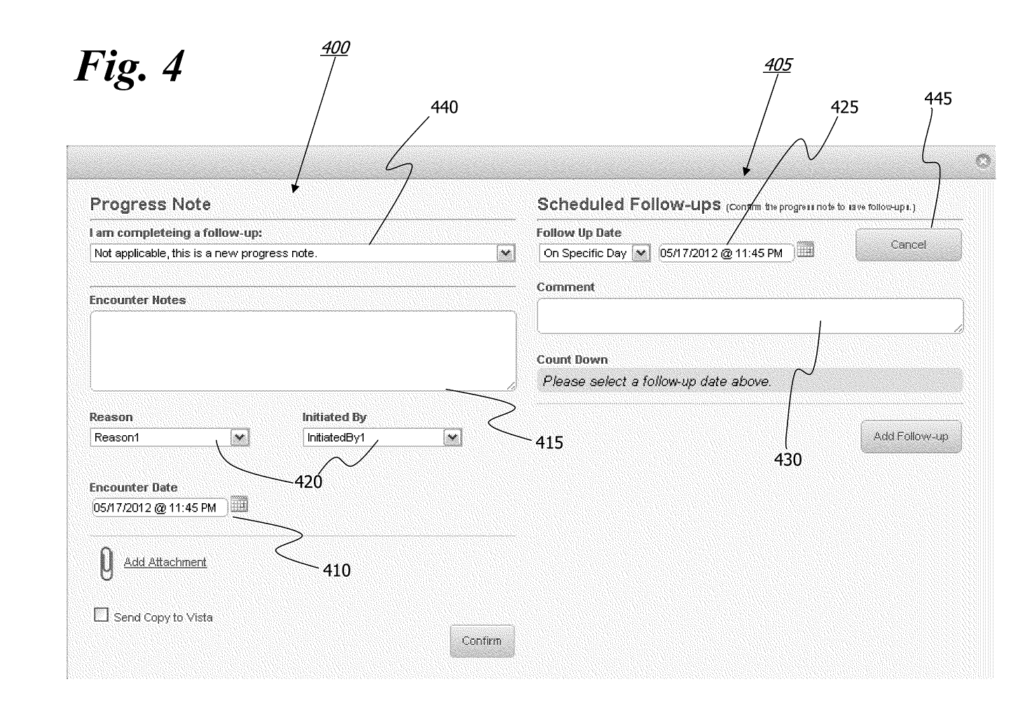

Facilitation of clinician workflow by the present invention can be understood in greater detail on inspection of FIG. 4, which shows a progress note GUI form according to the present invention. Proactive management of the health of a population of chronically ill patients has the goals of reducing hospitalizations, reducing the cost of care, improving patient quality of life, and maximizing the number of patients that can be managed per health care worker. Broadly, this workflow amounts to:
1. Proactive contact with patients exhibiting health deviations;
2. Resolving incipient health deterioration with ameliorative low impact medical interventions; and
3. Scheduling follow-up contact with patients to verify the medical intervention was effective and that the patient is complying with instructions.

Identification of (1) above is facilitated by the health progression ranking of column 225. Any contact with a patient constitutes a patient encounter and is provided for in the system of the present invention by a progress note 400. Hence the contact of (1) and resolution of what action to take in (2) is memorialized in the system by means of the progress note. At the time the clinician fills out a progress note, the clinician has the option under the inventive system to schedule one or more follow-ups 405 to meet the needs of (3). While a progress note 400 comprises multiple fields of data, including a encounter date timestamp 410, an encounter notes narrative field 415, the identity of the clinician who performed it, and optionally one or more categoricals 420 (category by which contact was initiated, category of reason of health deviation, etc.) and other fields of data, the follow-up 405 comprises a scheduled timestamp 425, an optional brief comment 430, and a status. The comment 430 may be used to differentiate intended reasons for the follow-up, such as “confirm patient refilled medications” and “contact patient to see how foot surgery went”. The status of a follow-up can be open/pending, closed, or cancelled. When the clinician makes a scheduled contact with the patient to satisfy a follow-up, a new progress note 400 is created by the clinician, and associated with the prior follow-up by means of selecting an outstanding follow-up from the list of pending follow-ups for that patient from drop-down control 440. When this new progress note is saved, the status of the prior pending follow-up that was selected from drop down 440 is marked as closed. A previously scheduled follow-up can also be cancelled, either by opening the parent progress note and clicking the cancel button 445 associated with that follow-up, or by right-clicking on the follow-up listed in column 245 and selecting “cancel” from a contextual popup menu that then appears.

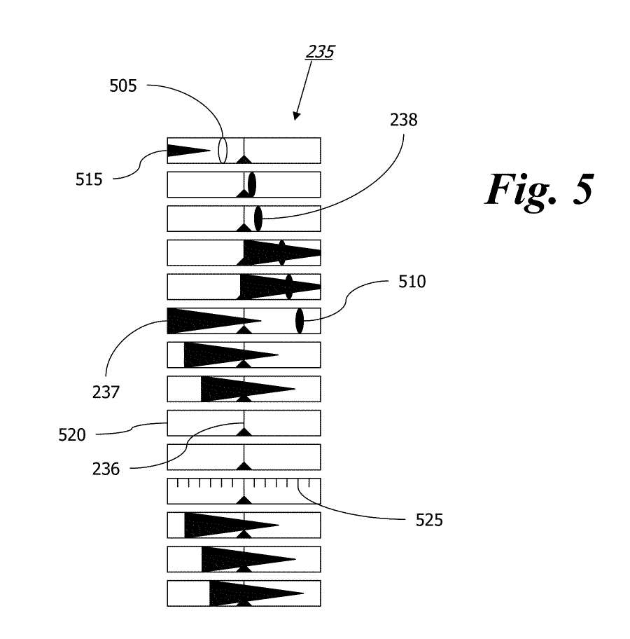

Hence clinical workflow is simply and efficiently facilitated in the present invention by chaining together progress notes to follow-ups to progress notes. Moreover, this workflow is efficiently visualized in the GUI widget of column 235, which is explained in greater detail with reference to FIG. 5. The column 235 therein is shown to have been sorted according to pending follow-ups 238 (the clinician has clicked on the sorting control above column 245). At the top of the list is an overdue follow-up 505, to the left of the “now” marker 236, which is differently shaded or colored from upcoming follow-ups, e.g., 238 and 510. All follow-ups displayed on the GUI widgets of column 235 are open/pending; cancelled or closed follow-ups are not displayed. In contrast to follow-ups, patient encounters (which are documented and timestamped by filling out progress notes) are indicated by tapering horizontal triangles 237, where the left edge of the triangle is located at the position corresponding to the time of the encounter. In a browser embodiment of the present invention, patient encounters are preferably visualized by shapes with fading color or shading from left to right. The tapering or shading conveys a visual sense that the pertinence of the patient encounter diminishes with time. The length over which this effect is visualized can be selected based on the policy of the institution using the system of the present invention; in a preferred embodiment the span of a patient encounter lasts 7 days. Of course, in the alternative a patient encounter can be indicated with just an icon located at the position corresponding to the date/time of the encounter, and no extended fading is then rendered; the clinician is still able to see when an encounter occurred. However, the trailing fade-away of the encounter has the advantage over a mere icon of indicating the presence of an encounter such as 515 that occurred just prior to the beginning of the timeline left edge 520, without using up valuable screen real estate to make the timeline wider. Column 235 can also be augmented with tick marks 525 to indicate days or other units of time.

The aforementioned screen renderings including the patient table 200, the columnar UT widgets and the progress note form, are generally implemented according to the present invention as program code that can be rendered by a client program on the computing unit used by the clinician. In the preferred embodiment, the client application is a web browser, and the program code comprises script instructions such as javascript, layout markup codes according to a markup language such as XHTML, and style codes such as cascading style sheets, together with data. Web pages are dynamically generated by the web server 140 based on a combination of templates and data retrieved from the database 130. Once a web page is instantiated in the client browser, additional or replacement data can be fetched from the server using AJAX queries as is known in the art. Collectively, the program code transforms the computing unit of the clinician into a machine for displaying and advantageously visualizing the meaningful prioritized patient data described above, with user controls actuated by clicks of a mouse, key strokes on a keyboard, or taps on a touch-screen of the clinician's computing unit to interactively change the sort order of the table, enter progress notes, scroll up and down the list, select items from drop down controls, and retrieve and save data to and from a database, in order to carry out the management of the health of the patient population in a proactive manner.

The client application need not be a browser, and can instead be a full-featured, self-contained executable on the clinician's computing device, that makes only requests for data to/from the server, in the traditional approach of client-server computing. As yet another alternative, the screen display can be a remote session whereby the client application actually is executed on a server located remotely from the clinician, and only screen updates and mouse/keyboard/touchscreen inputs are transmitted to and from the computing unit the clinician is actually using.

In a preferred embodiment of the invention, the health index values are determined from results of analysis of the physiological feature variables of a patient using a multivariate empirical estimator model personalized to the patient. Accordingly, a model comprises a reference library of observations of said feature variables from the patient obtained when the patient's health is deemed “baseline” or stable. The reference library should include values for the feature variables that span a range of normal variation witnessed in the patient during routine activities, for example heart rates spanning at rest (60 bpm) to some moderate level of activity (110 bpm) or even higher if such vital signs can reliably be recorded. Once this reference library has been “learned”, the model can be used to create estimates of expected values based on newly monitored observations of the feature variables, whereby the estimated values form a dynamic baseline for comparison, effectively removing the confounding effect of normal physiological variation due to normal metabolic demands, and revealing subtle shifts in the feature variables, e.g., heart rate 5% higher than expected for the inputted pattern of features. Upon monitoring a new observation, the model utilizes a kernel function to compare the new observation to at least some observations in the reference library. The kernel function renders a similarity score for each such comparison, which:
1. Lies in a scalar range, the range being bounded at each end;
2. Has a value of one of the bounded ends, if the two observation vectors are identical;
3. Changes monotonically over the scalar range; and
4. Has an absolute value that increases as the two observation vectors approach being identical.

These similarity scores are then used as weights in a linear combination of observations from the reference library that yields an estimate of expected values for said observation:

$${\hat{x}}_{i n} ( t ) = \frac{D ( t ) {( {D ( t )}^{T} ⊗ D ( t ) )}^{- 1} ( {D ( t )}^{T} ⊗ {x}_{i n} ( t ) )}{\sum {( {D ( t )}^{T} ⊗ D ( t ) )}^{- 1} ( {D ( t )}^{T} ⊗ {x}_{i n} ( t ) )} , D ( t ) = \{ H \vert F ( H , {x}_{i n} ( t ) ) \}$$

Here, xᵢₙ(t) is the input observation at time t; D(t) is a set of reference observations selected from the reference library H according to function F (for example a k-nearest neighbor or effectively similar approach); x-hatᵢₙ(t) is the estimated observation produced by the model. The kernel function is shown as \textcircled{x} whereby each column vector from the first operand (which can be a matrix, such as D is) is compared for similarity to each row vector of the second operand (which can also be a matrix). The above equation should be understood to be matrix algebra, where all vectorized variables are shown in bold. The estimated observation is in this case an autoassociative estimate, by which is meant that each feature variable present in the estimate is also present in the input observation.

The estimated values are then differenced with the monitored values of the feature variables to yield residuals. Each vital sign thus has a residual which is the difference between the expected value and measured value. Importantly, the instant multivariate residuals are fused into a single health index scalar value for the timestamp of the input observation. In the preferred embodiment, the residual vector is compared to a distribution of residual vectors derived for normal physiology of the patient, and the likelihood that the new residual vector belongs to that distribution or not is used to generate the health index value. It can be understood that with sensor noise and model noise, residuals even for observations of vital signs during normal physiological stability for the patient can give rise to transient, non-zero residuals. This is what gives the normal residual distribution its “spread”. The likelihood that the instant residual vector belongs to the distribution or not is a measure of how much anomaly is present in the physiology of the patient represented by the monitored observation; in this manner the instant health index value reflects the normalcy or abnormality of the monitored observation of feature variables.

It will be appreciated by those skilled in the art that modifications to the foregoing preferred embodiments may be made in various aspects. Other variations clearly would also work, and are within the scope and spirit of the invention. The present invention is set forth with particularity in the appended claims. It is deemed that the spirit and scope of that invention encompasses such modifications and alterations to the preferred embodiment as would be apparent to one of ordinary skill in the art and familiar with the teachings of the present application.

1. A computer apparatus for use in prioritizing intervention with a population of patients, comprising:
a display;
at least one processor; and
a computer memory having program code stored therein which is accessed by and executed on said at least one processor to perform the steps of:
fetching health index time series data for multiple patients from a database;
rendering on the display a table comprising rows, each of which corresponds to a patient;
rendering on the display in a column of said table a timeline visualization for each patient, each said timeline visualization displaying a visual cue on said timeline at each time point corresponding to said health index time series, each said visual cue having an appearance graded to the value of said health index at that time;
sorting the rows of the table according to a scalar value derived for each patient as a weighted average of the values of said health index time series over the timeline, giving greater weight to more recent health index values.

2. The computer apparatus according to claim 1, wherein said health index characterizes a degree of abnormality from expected behavior of a patient's physiology as represented by a plurality of physiological feature variables.

3. The computer apparatus according to claim 2, wherein the degree of abnormality characterized by the health index at a given time is determined by comparing a vector of residuals for the plurality of physiological feature variables measured from the patient at said given time, to a distribution of residual vectors for the plurality of physiological feature variables derived for normal physiology of the patient.

4. The computer apparatus according to claim 3, wherein the residuals are generated by differencing measured values of the plurality of physiological feature variables with expected values of the plurality of physiological feature variables provided by a model personalized to the patient.

5. The computer apparatus according to claim 1, wherein said program code is accessed and executed on said at least one processor to perform the further step of rendering a background shading of said timeline visualization according to sunrise and sunset times.

6. (canceled)

7. The computer apparatus according to claim 1, wherein said program code is accessed and executed on said at least one processor to perform the further steps of:
fetching patient encounter data for multiple patients from a database; and
rendering on the display in a column of said table a timeline visualization for each patient with a visual cue on said timeline at each time point a patient encounter occurred.

8. (canceled)

9. The computer apparatus according to claim 2 wherein said scalar value is derived as an exponentially weighted average of said health index time series such that each health index value is weighted according to an exponential factor that increases with increasing recentness of the time point of the health index value.

10. The computer apparatus according to claim 9 wherein said exponentially weighted average E of said health index time series h(i) is computed according to:
$$E = \frac{{\sum }_{i = 1}^{N} h ( i ) \cdot {e}^{\frac{- ( N - i )}{A}}}{{\sum }_{i = 1}^{N} {e}^{\frac{- ( N - i )}{A}}}$$
where N is the number of data points in said health index time series and A is a selected bandwidth.

11. A computer apparatus for use in managing a population of patients with monitored physiological feature variables, comprising:
a display;
at least one processor; and
a computer memory having program code stored therein which is accessed by and executed on said at least one processor to render interactive elements on said display comprising:
a table comprising rows, each of which corresponds to a patient;
a health timeline column of said table containing a timeline visualization of a health index time series derived from said physiological feature variables, the rows of said table sortable according to a scalar value derived as a weighted average of the values of said health index time series, giving greater weight to more recent health index values;
a patient encounter column of said table, the rows of said table sortable according to the most recent patient encounter date; and
a follow-up column of said table, the rows of said table sortable according to the earliest open follow-up.

12. The computer apparatus according to claim 11, wherein said scalar value is derived as an exponentially weighted average of said health index time series such that each health index value is weighted according to an exponential factor that increases with increasing recentness of the time point of the health index value.

13. The computer apparatus according to claim 12 wherein said health index characterizes a degree of abnormality from expected behavior of a patient's physiology determined by comparing a vector of residuals for the plurality of physiological feature variables measured from the patient at said given time, to a distribution of residual vectors for the plurality of physiological feature variables derived for normal physiology of the patient.

14. The computer apparatus according to claim 13, wherein the residuals are generated by differencing measured values of the plurality of physiological feature variables with expected values of the plurality of physiological feature variables provided by a model personalized to the patient.

15. (canceled)

16. A system for use in managing a population of patients with monitored physiological parameters, comprising:
a sensing device for acquiring biosignals from a patient from which physiological parameters are derived;
a data hub for collecting physiological data from said sensing device and transmitting such data over a network;
a data store for receiving the transmitted data and storing it in association with each patient;
an analytics server for analyzing multivariate physiological parameter data of each patient using a model of expected physiological behavior to render a health index; and
a web server for serving over a network at least one web page to a client application executable on a user's computing device, said web page comprising program code interpretable by said client application for rendering on a display of the user's computing device:
a table with rows corresponding to patients; and
a health progression timeline visualization in each row for displaying visual cues representative of a time series of said health index;
said table being sortable according to a health progression scalar value for each patient derived as a weighted average of the values of said health index time series, giving greater weight to more recent health index values.

17. The system according to claim 16, wherein said health progression scalar value is derived as an exponentially weighted average of said health index time series such that each health index value is weighted according to an exponential factor that increases with increasing recentness of the health index value.

18. The system according to claim 17, wherein said sensing device is a wearable device and said data hub is a smartphone configured to upload physiological data over at least a telecommunications network.

19. The system according to claim 17, wherein said sensing device is an implant device.

20. The system according to claim 16, wherein said physiological parameters include more than one selected from the set comprising a measure of heart rate (HR), respiration rate (RR), blood pressure (BP), pulse transit time (PIT), blood oxygenation (SpO2), posture, and gross activity.

21. The system according to claim 16, wherein said health index characterizes a degree of abnormality from expected behavior of a patient's physiology determined by comparing a vector of residuals for the multivariate physiological data measured from the patient at said given time, to a distribution of residual vectors for the multivariate physiological data derived for normal physiology of the patient.

22. The computer apparatus according to claim 21, wherein the residuals are generated by differencing measured values of the multivariate physiological data with expected values of the multivariate physiological data provided by a model personalized to the patient.

23. The computer apparatus according to claim 4, wherein said scalar value is derived as an exponentially weighted average of said health index time series such that each health index value is weighted according to an exponential factor that increases with increasing recentness of the time point of the health index value.

24. The computer apparatus according to claim 23, wherein said exponentially weighted average E of said health index time series h(i) is computed according to:
$$E = \frac{{\sum }_{i = 1}^{N} h ( i ) \cdot {e}^{\frac{- ( N - i )}{A}}}{{\sum }_{i = 1}^{N} {e}^{\frac{- ( N - i )}{A}}}$$
where N is the number of data points in said health index time series and A is a selected bandwidth.
